(19) United States
(12) Patent Application Publication
(10) Pub. No.: US 2015/0301733 A1
(43) Pub. Date: Oct. 22, 2015

(54) METHOD AND APPARATUS FOR PROVIDING STATE IDENTIFICATION

(71) Applicant: William Carl Acevedo, Hazlet Twp., NJ (US)

(72) Inventor: William Carl Acevedo, Hazlet Twp., NJ (US)

(21) Appl. No.: 14/691,137

(22) Filed: Apr. 20, 2015

Related U.S. Application Data
(60) Provisional application No. 61/981,908, filed on Apr. 21, 2014.

(51) Int. Cl. G06F 3/0484

(52) U.S. Cl. CPC G06F 3/04847; G06F 3/04842

(57) ABSTRACT

A computer implemented method and apparatus for providing state identification. The method comprises (a) displaying a first state identifier, wherein the state identifier comprises a first state element and a first plurality of navigation cues associated with the first state element; (b) receiving an input to move toward one of the first plurality of navigation cues; (c) storing the first state element in a navigation path in response to the received input to move; (d) displaying a second state element and a second plurality of navigation cues associated with the second state element; (e) optionally repeating the process of (b)-(d) for additional state elements to arrive at a final state element, which may be the second state element; (f) receiving a selection of the final state element; and (g) storing the selected final state element and updating the navigation path based on the received selection.

### CROSS-REFERENCE TO RELATED APPLICATIONS

This application claims priority to U.S. Provisional Patent Application Ser. No. 61/981,908 filed Apr. 21, 2014, which is incorporated by reference herein in its entirety.

### BACKGROUND OF THE INVENTION

1. Field of the Invention

Embodiments of the present invention generally relate to state identification and, more particularly, to techniques for providing more precise state identification.

2. Description of the Related Art

Oftentimes, users are asked to identify state information, such as a pain assessment on a pain scale or sentiment identification via selection of an emoticon. Current state information is often vague and lacks true accuracy or detail. For example, selecting a smile (happy) emoticon does not identify whether the sentiment is true or sarcastic, and further does not convey a degree of happiness. Identifying pain on a pain scale may loosely identify the intensity of the pain but does not identify important attributes such as the type, frequency, or duration of the pain. In areas such as medical evaluation where requested information should be as specific and detailed as possible, current state identifiers are flawed.

Therefore, there is a need for a method and apparatus for providing improved state identification.

### SUMMARY OF THE INVENTION

An apparatus and/or method is provided for providing state identification substantially as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIGS. 1A-1C collectively depict a block diagram of a system for providing state identification, according to one or more embodiments;

FIG. 2 illustrates the parts of a state identification grid, according to one or more embodiments;

FIG. 3 depicts a flow diagram of a method for providing state identification, according to one or more embodiments;

FIGS. 4A-4B depict user interfaces for providing emotional state information, according to one or more embodiments;

FIG. 5 depicts a user interface for providing pain state information, according to one or more embodiments;

FIGS. 6A-6B depict user interfaces for providing emotional state information, according to one or more embodiments; and

FIG. 7 depicts a computer system that can be utilized in various embodiments of the present invention.

While the method and apparatus is described herein by way of example for several embodiments and illustrative drawings, those skilled in the art will recognize that the method and apparatus for providing state identification is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus for providing state identification defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

Embodiments of the present invention provide a method and apparatus for providing state information. An interface developer may create a plurality of grids for use in providing state information that can be embedded within a software program or application (referred to herein as “on board”) or integrated with a state grid creation utility (referred to herein as “off board”). One or more grids may be created for each use type. For example, there may be one or more state information grids created to replace multiple keyboard layers, one or more that assess a user's pain, one or more that assess a user's sentiment, one or more that assess a user's satisfaction, one or more that present survey questions, and the like. Each state information grid may be created from with a state grid creation utility and may access grid templates to simplify development.

Each state information grid includes a plurality of cells. Each cell includes a state element which may be images, words, sounds, a video, any media, or combination of media that conveys an appropriate representation for a given state. Each cell may also include navigation cues to assist a user in locating and selecting an optimal state identifier. In some embodiments, each cell includes a link to a different state information grid, such that upon selection of the cell by a user, a new state information grid is displayed that allows a user to select from additional state identifiers that provide more granular or relevant feedback. The developer may also indicate a default starting cell to display to the user upon the initial display of the state information grid. When the developer completes creation of a state information grid, the state information grid may be stored “on board” or “off board”.

The state information grid may be included as a feature or attribute in an application on a user's device (i.e., on board) or the state information grid may be accessed on the server (i.e., off board) by a user. Upon display of the state information grid, the user may select a cell from the state information grid that best identifies their current state. As the user provides input with a finger, stylus, or other input device, technology, or sensor to progress along the grid, navigation cues are displayed to the user that direct the user where to move next so as to arrive at a cell that represents the desired state of the user. For example, in a pain assessment, a cue may indicate that moving to the right indicates a more throbbing pain and less of a sharp pain which may be located to the left. In addition, moving further from, for example, a centrally located default cell may indicate an increased intensity in the type of pain the user is moving towards. Thus, the user may provide two extremely accurate and valuable pieces of information with a single, simple input. As the user moves through the grid, each cell that the user activates is stored such that the path the user took to arrive at their current state as well as an amount of time spent viewing the cell is known. When the user is satisfied with their selection, the state element in the selected cell, the path to arrive at the selected cell, along with the time spent viewing the cells along this path are stored. As such, the present invention provides a method of improved state identification by retrieving more detailed and accurate state information.

Embodiments of the present invention may be used to provide state identification on states that are physiological, emotional, psychological, environmental, or any area where state elements are definable or conveyable. As used herein, the term state identification refers to the providing of information observed or experienced by a user or any type of user feedback that may be requested of a user.

Various embodiments of a method and apparatus for providing state identification are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description that follow are presented in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

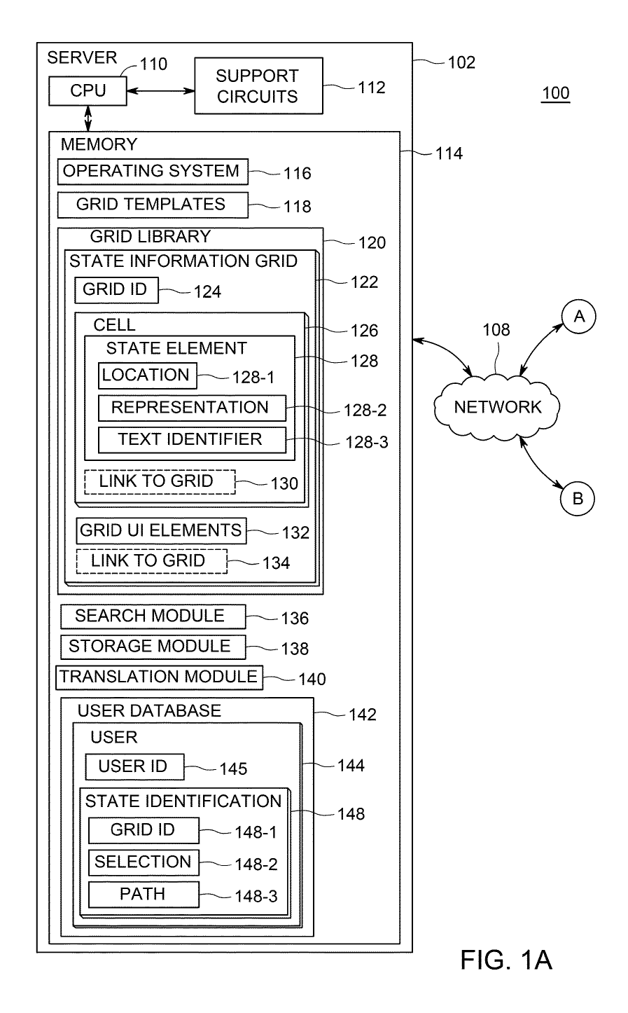

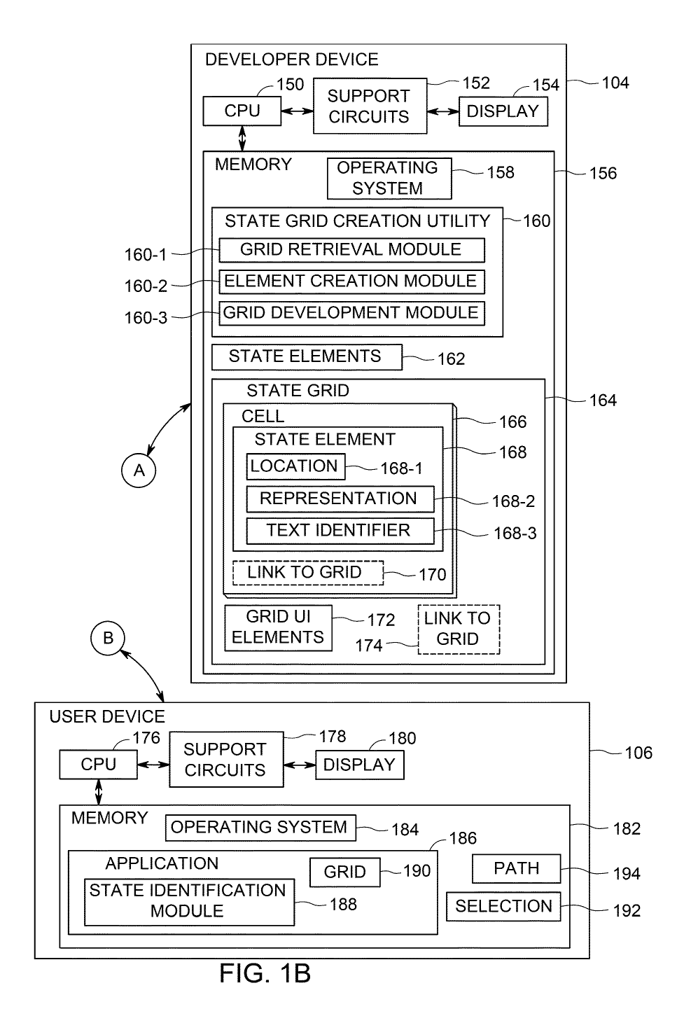

FIGS. 1A-1C collectively depict a block diagram of a system 100 for providing state identification, according to one or more embodiments. The system 100 includes a server 102, a developer device 104, and a user device 106, communicatively connected via network 108. An interface developer creates a state identification grid which, in some embodiments, is stored on the server 102. In some embodiments, a user accesses the state identification grid from the user device 106 to provide a state identification. The server 102 is a type of computing device known to one of ordinary skill in the art. The server 102 may be in the cloud. Examples of the server 102 include, but are not limited to a blade server, virtual machine, and the like. Additional examples of the server 102 include, but are not limited to desktop computers, laptops, tablet computers, Smartphones, and the like. The server 102 includes a Central Processing Unit (CPU) 110, support circuits 112, and a memory 114. The CPU 110 may include one or more commercially available microprocessors or microcontrollers that facilitate data processing and storage. The various support circuits 112 facilitate the operation of the CPU 110 and include one or more clock circuits, power supplies, cache, input/output circuits, and the like. The memory 114 includes at least one of Read Only Memory (ROM), Random Access Memory (RAM), disk drive storage, optical storage, removable storage and/or the like.

The memory 114 includes an operating system 116, a plurality of grid templates 118, a grid library 120, a search module 136, a storage module 138, a translation module 140, and a user database 142. The operating system 116 may include various commercially known operating systems. The grid library 120 includes a plurality of state information grids 122 that may be used to provide state identification. Each state information grid 122 may include a grid identifier 124, a plurality of cells 126, grid user interface (UI) elements 132, and an optional link 134 to another grid. Each cell 126 includes a state element 128, and optionally, a link 130 to another state identification grid 122. Each state element 128 includes a location 128-1, a representation 128-2 of the state element 128, and a text identifier 128-3. The representation 128-2 may be text, images, video, or any media that represent a user's state. The text identifier 128-3 is a text description of the state identified by the state element 128. The grid UI elements 132 may include but are not limited to keywords associated with the grid 122, a text label for the grid 122, instructions for using the grid 122, positions in the UI for navigation cues, UI buttons, information provided to the user based on the user's selections, such as encouragement, results, representations, scoring, reinforcement, random messages, and the like.

The user database 142 includes a plurality of users 144. Each user 144 includes user identification 146, and one or more accessible or completed state identifications 148. Each state identification 148 includes the grid identifier 148-1 of the state information grid 122 from which the state was identified as well as the user selection 148-2 and the path 148-3 the user 144 took to arrive at the selection 148-2. The path 148-3 is a series of state elements 128 navigated through before arriving at the selection 148-2. In some embodiments, the path 148-3 may include a timestamp identifying when the state element 128 was activated.

The developer device 104 is a type of computing device known to one of ordinary skill in the art. The developer device 104 may include, but is not limited to desktop computers, laptops, tablet computers, Smartphones, and the like. The developer device 104 includes a Central Processing Unit (CPU) 150, support circuits 152, a display 154, and a memory 156. The CPU 150 may include one or more commercially available microprocessors or microcontrollers that facilitate data processing and storage. The various support circuits 152 facilitate the operation of the CPU 150 and include one or more clock circuits, power supplies, cache, input/output circuits, and the like. The memory 156 includes at least one of Read Only Memory (ROM), Random Access Memory (RAM), disk drive storage, optical storage, removable storage and/or the like.

The memory 156 includes an operating system 158, a state grid creation utility 160, state elements 162, and a state grid 164. The state grid creation utility 160 includes a grid retrieval module 160-1, an element creation module 160-2, and a grid development module 160-3.

Each state grid 164 may include a plurality of cells 166, grid user interface (UI) elements 172, and an optional link 174 to another grid. Each cell 166 includes a state element 128, and optionally, a link 130 to another state identification grid 122. Each state element 168 includes a location 168-1, a representation 168-2 of the state element 168, and optionally, a text identifier 168-3. The representation 168-2 may be text, images, video, or any media or combination of media that represent a user's state. The optional text identifier 168-3 is a text description of the state identified by the state element 168. The grid UI elements 162 may include but are not limited to keywords associated with the state grid 164, a text label for the grid 164, instructions for using the grid 164, positions in the UI for navigation cues, UI buttons, information provided to the user based on the user's selections, such as encouragement, results, representations, scoring, reinforcement, random messages, and the like.

The state elements 162 may be created using the element creation module 160-2, edited from existing state information grids 122, or imported from third-party servers (not shown). The operating system 158 may include various commercially known operating systems.

The user device 106 is a type of computing device known to one of ordinary skill in the art. The user device 106 may include, but is not limited to desktop computers, laptops, tablet computers, Smartphones, gaming systems, kiosks, and the like. The user device 106 includes a Central Processing Unit (CPU) 176, support circuits 178, a display 180, and a memory 182. The CPU 176 may include one or more commercially available microprocessors or microcontrollers that facilitate data processing and storage. The various support circuits 178 facilitate the operation of the CPU 176 and include one or more clock circuits, power supplies, cache, input/output circuits, and the like. The memory 182 includes at least one of Read Only Memory (ROM), Random Access Memory (RAM), disk drive storage, optical storage, removable storage and/or the like.

The memory 182 includes an operating system 184, an application 186 that includes a state identification module 188 and may include or import one or more grids 190. The memory may also store a selection 192 and a path 194 taken to arrive at the selection. The operating system 184 may include various commercially known operating systems. In some embodiments, the application 186 may be an embedded software operation or a standalone over-the-top (OTT) application installed on device 106 with an application programming interface (API) to interact with the state identification module 188. In some embodiments, the state identification module 188 may be an applet/widget made to interact with an OTT application 186.

The network 108 includes a communication system that connects computers (or devices) by wire, cable, fiber optic and/or wireless link facilitated by various types of well-known network elements, such as hubs, switches, routers, and the like. The network 108 may be a part of the Intranet using various communications infrastructure, such as Ethernet, Wi-Fi, a personal area network (PAN), a wireless PAN, Bluetooth, Near field communication, cellular communication, and the like.

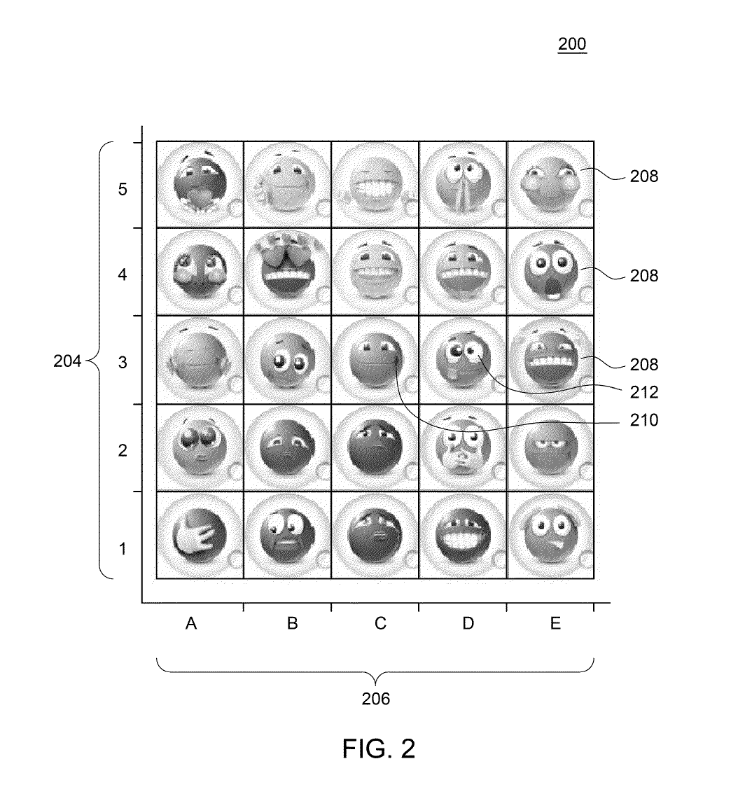

A developer may use the state grid creation utility 160 to create a state information grid 122 on display 158. FIG. 2 illustrates an embodiment of a state grid 200 for providing an emotional state. In such embodiment, the state gird 200 includes five rows 204 and five columns 206 with twenty-five cells 208. In some embodiments, the actual grid 200 may not be displayed in the user interface. In some embodiments, the actual grid 200 may extend beyond the visible display area; however, the information in FIG. 2 illustrates what the developer associates with each cell. Using the grid retrieval module 160-1, the developer may select a grid template 118 from the server 102 as a starting point to create a state information grid 122. If the developer wishes to create a state information grid 122 based on an already created state information grid 122, the developer may enter one or more keywords into the grid retrieval module 160-1 in order to retrieve a state information grid 122 which may then be edited. The grid retrieval module 160-1 sends a request to the server 102, where the search module 136 performs a search for one or more grid templates 118 or state information grids 122. Alternatively, the developer may use the grid development module 160-3 to create a state grid 164 from scratch specifically for the application 186. The grid development module 160-2 may be used to add, edit, omit, or merge cells in an existing state information grid 122 in order to tailor the grid 122 to a specific need.

The grid development module 160-3 facilitates the entry of state elements 162 into the state grid 164. The state elements 162 may be imported from an outside source or the state elements 162 may be created using the element creation module 160-2. The element representation 168-2 may be text, images, video, or any media or combination of media that represent a user's state. As shown in FIG. 2, each cell 208 has a unique image (i.e., element representation 168-2). Using the grid development module 160-3, the developer assigns a unique state element 168 to each cell 166 of the state grid 164. Each unique state element 168 may be defined by the location 168-1, representation 168-2 and optionally, text identifier 168-3.

For example, in FIG. 2, the center cell 210, at row 3, column C, which may define the element location 168-1 as 3C has a representation 168-2 of an image of a neutral face indicating a neutral emotion. The text identifier 168-3 may be “Neutral”. In the present example, navigation cues for the center cell may be “sincere”, “playful”, “happy”, and “sad” and would be situated on the left, right, top, and bottom of the grid, respectively. The text identifier 128-3 of each cell may serve as a navigation cue to assist a user in locating and selecting the optimal state identifier. In FIG. 2, the text identifier 168-3 of the state element 168 at location 3B is “sincere”. The text identifier 168-3 of the state element 168 at location 3D is “playful”. The text identifier 168-3 of the state element 168 at location 4C is “happy”. The text identifier 168-3 of the state element 168 at location 2C is “sad”. As such, the text identifiers 168-3 of the state elements 168 of the adjacent cells 166 serve as the navigation cues for the cell 3C.

The developer may assign which orientation of state elements will act as navigation cues to each cell. When a user navigates through the grid toward a navigation cue, the user is moved from a first cell to a second cell. For example, using the state grid of FIG. 2, when a user moves toward the navigation cue for “playful”, the user navigates from the cell located at row 3, column C to the cell located at row 3, column D. The representation 168-2 associated with the current cell is displayed and the navigation cues associated with the adjacent state elements are displayed. If the display of the user device doesn't support user access to all cells the cells may be moved towards the default cell or be moved towards the center of the display when the user input reaches the outer boundaries of the device's display area.

In some embodiments, the developer may associate a link 170 with a cell. The link 170 indicates a next grid to display to the user where the grid includes additional state elements that define more granular states associated with the state element of the cell. For example, a state grid 164 may be designed to receive user's favorite type of music from state elements 168 for example, “Pop”, “R&B”, “Electronic”, “Latin”, “Holiday Classics”, “Blues”, “Rock”, and “Country”. When a selection is made of the state element 168 associated with “Country”, a link 170 may identify another state grid 164 with additional state elements that define more granular states identifiers associated with the state element “Country”. For example, the next state grid 164 may include the state elements 168 of “Contemporary”, “Traditional”, “Classic”, “Bluegrass”, “Alternative”, “Texas/Red Dirt”, “Outlaw”, and “Honky Tonk”.

In addition, the developer may define a link 174 to another grid that is displayed upon submission of a state on first state gird 164 in order for the user to provide additional information related to the subject of the first state grid 164. For example, a user may select a state element for a pain assessment that indicates a type of pain. Upon submission of the pain assessment, another grid may be displayed in order for the user to indicate a location of the pain. Upon completion of the location grid, the developer may link yet another grid such that the user may indicate duration of the pain or other pertinent information. As such, the developer may provide a link 174 with each state grid 164 that links to a next grid to be completed by the user thereby creating relationships (i.e., parent/child) between state information grids 122. The grid development module 160-3 further allows the developer to input grid UI elements 172, including, but not limited to instructions to assist the user in understanding the context of the state grid 164 as well as to instruct the user in how to use the grid and make a selection, and the like. Those skilled in the art will appreciate that the grid UI elements 172 provided with the grid is not limited to that described above. Additional information may be provided with the grid 164 without deviating from the spirit of the invention. In some embodiments, the state grid creation utility 160 transmits the completed state information grid 164 to the server 102, where the storage module 138 stores the received grid 164 in the grid library 120 with a unique grid identifier 124. The grid is stored with cells 126, state elements 128, grid UI elements 132 and optionally link 134. In some embodiments, the storage module 138 maintains versioning of the state information grids 122, and also stores a developer identifier for the developer who created the state information grid 122, as well as a device type(s) on, or for which the grid was created, a category of the grid, and the like.

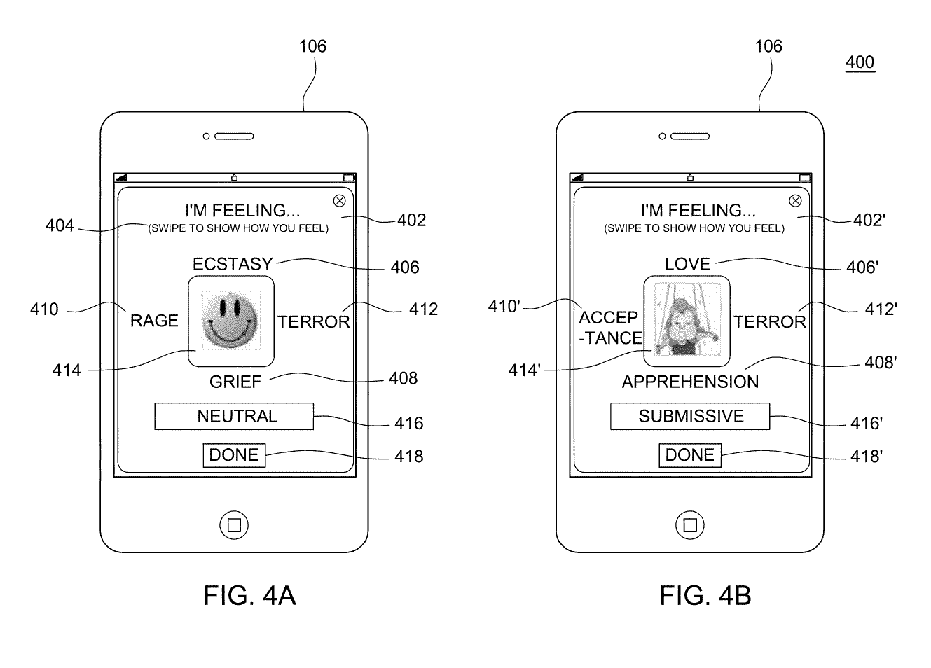

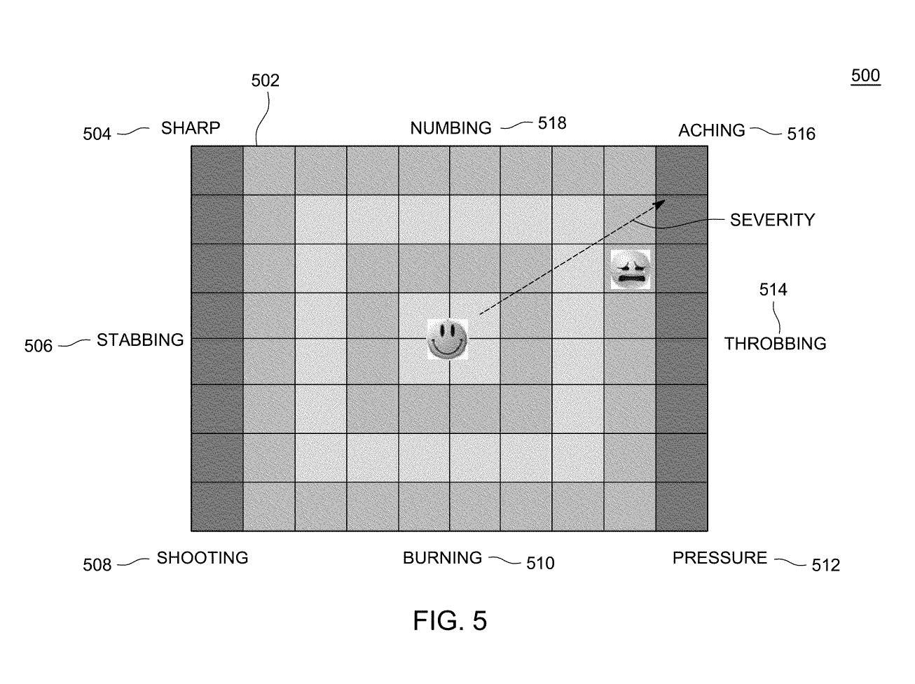

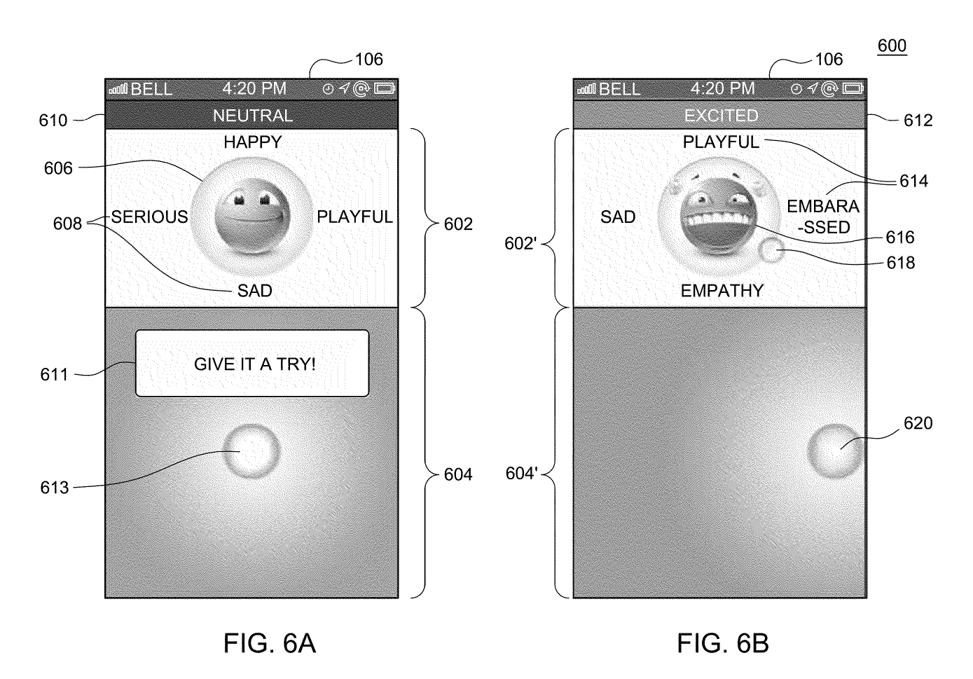

A user may open an application 186 stored on board or accessed off board on user device 106. In some embodiments, the application 186 may require authentication of the user. In such embodiments, a user may log in to the server 102 or application where the server or application verifies the user 144 against the user identification 146. User identification 146 may be a login and password, a voice print, or any verifiable information known in the art. The user requests to open the state identification grid 190. In some embodiments, the request includes a language or other personalization features defined by the developer, in which the state identification grid 190 is to be displayed. In some embodiments, the state identification grid 190 is retrieved from the server 102, translated by the translation module 140, and displayed by the state identification module 188 on display 180. In some embodiments, the state identification grid 190 is stored on the server 102 in a plurality of languages and the state identification grid 190 in the preferred language is retrieved. In some embodiments, the state identification grid 190 may be installed on the user device 106 with the software, operating system 184, or application 186, where it may be translated before it is displayed. In such embodiments the state identification grid 190 may be synchronized with the state identification grid 122 on the server 102 in order to update the state identification grid 190 with any updates made by the developer. The state identification module 188 displays the state identification grid 190 on display 180. The user interface of the state identification grid 190 is described in detail with respect to FIG. 4, FIG. 5, and FIG. 6, below.

The state identification module 188 may indicate a default starting point by displaying the default state element as well as navigation cues from the starting point. As the user navigates toward a navigation cue, the state identification module 188 stores each cell that was navigated through and a timestamp when each cell was navigated through, before arriving at the final selection 192. When the user submits the final selection 192, the final selection 192 and path 194 taken to navigate to the final selection 192 are stored on the user device 106. In some embodiments, the final selection 192 and path 194, which includes the timestamp, are transmitted to the server 102 and stored in the user database 142 as selection 148-2, path 148-3, along with the grid identifier 148-1 for the state information grid 122 from which the selection was made. In some embodiments, the final selection 192 and path 194, in addition to the grid identifier 124 are transmitted to a third-party server (not-shown).

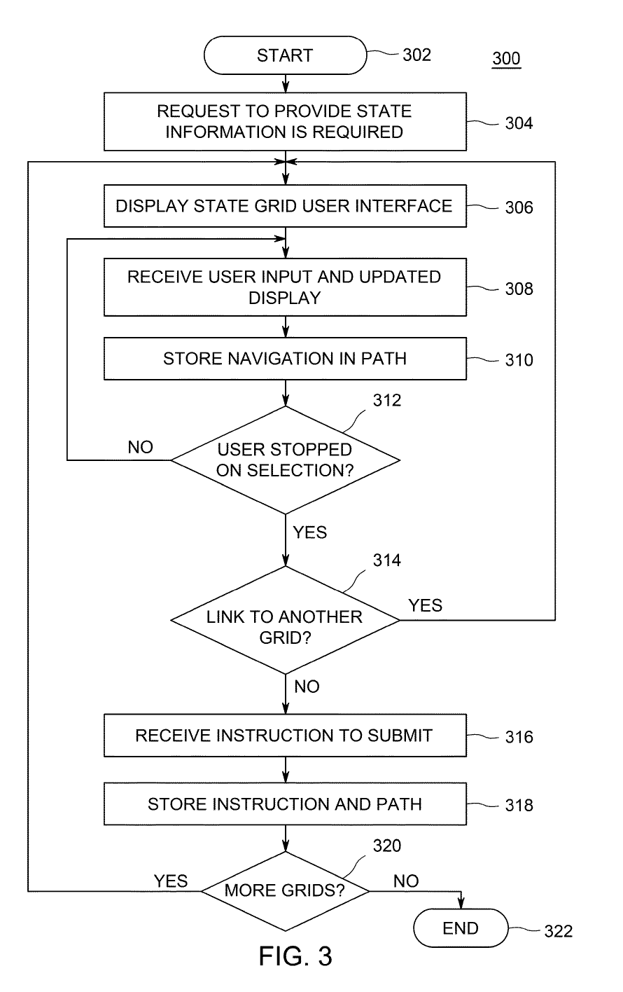

FIG. 3 depicts a flow diagram of a method 300 for providing state identification, according to one or more embodiments. The method 300 is performed by the state identification module 197 on user device 106. The method 300 starts at step 302 and proceeds to step 304.

At step 304, a request to provide state information is received. The request may be received via a user interface. The request may be received by an application attempting to automatically launch a state information grid.

At step 306, the state information grid user interface is displayed. In some embodiments, the state information grid is installed on the user device. In some embodiments, the state information grid is retrieved from a server. In such embodiments, a request is transmitted to the server with a grid identifier and the state information grid is received on the user device. The state information user interface may indicate a default starting state element and navigation cues. In some embodiments, text is displayed along with any defined media identifying a current selected state. If instructions were provided for the state information grid, the instructions are also displayed. Optionally, a starting point state element may be determined based on calculated analytics, such as a most common selection by users, an average of the user's past selected state, cohort analysis and the like. In such cases, the determined starting point state element is displayed with navigation cues adjacent to or associated with the cell that contains the determined starting point state element.

At step 308, user input is received. User input may be received via using any interface option available on the user device. For example, user input may be via a keyboard, navigation buttons, a track ball, micro-electromagnetic systems (MEMS) sensor, a computer mouse, motion detection, an eye tracking camera, brain computer interface (BCI), and the like. The user input navigates the user to a new cell in the input area of the state information grid. At each new cell, the state element for the cell is displayed as well as navigation cues that reflect the now relevant options for the newly presented state element. At step 310, the user input is stored. As the user input is received, the path the user takes to navigate through the state information grid is stored along with a timestamp at each cell.

At step 312, it is determined whether the user has selected a cell directly, is moving to a new cell, or has stopped on and selected a cell. A cell may be determined to be selected when a user releases the cell (e.g., removes a finger from the cell). In some embodiments, if the user remains on a selected cell beyond a predefined threshold, for example, three seconds, the input is determined that the user has stopped. If the user does not remain on the cell for the predefined threshold, the method 300 proceeds to step 308 and iterates until the user stops on and releases a cell. However, if it is determined that the user has stopped on and/or released the cell, the method 300 proceeds to step 314.

At step 314, it is determined whether the current cell is a parent to another state information grid (i.e., whether there is a link from the current cell to another state information grid.) If the current cell is linked to another grid, the method 300 proceeds to step 306 and iterates until the user selects a final selection cell. However, if at step 314, it is determined that the cell is not linked to another state information grid and the current cell is the final selection cell, the method 300 proceeds to step 316, where the method 300 receives an instruction to submit the selection. The instruction may be received, for example, when a user releases the display, when a user selects a button on the display of the user device, or when a defined sensor input threshold is met, indicating that the user's selection is complete.

At step 318, the final selection and the path to arrive at the final selection, including timestamps is stored on the user device. In some embodiments, the user final selection and path are transmitted to the server and stored in a user database.

At step 320, it is determined whether the state information grid is a parent to another state information grid. For example, the current state information grid may enable a user to provide a pain assessment. After the pain assessment is complete, the grid may be linked to another grid that enables a user to provide additional information, such as pain severity, pain duration, or pain location. If it is determined that the grid is linked to another state information grid, the method 300 proceeds to step 306. However, if the grid is not linked to another state grid, the method proceeds to step 322 and ends.

FIGS. 4A-4B depicts a user interface 400 for providing emotional state information, according to one or more embodiments. FIG. 4A depicts a user device 106 when the state information grid is initiated. The user device 106 includes a display area 402. On the display area, information 404 such as an explanatory comment is displayed to instruct the user. A default starting state element 414 is displayed with navigation cues 406, 408, 410, and 412 around the state element 414. In the present example, the navigation cues 406 and 408 are displayed on opposite sides of the state element 414 and are opposite emotions, such as “ecstasy” and “grief”. Similarly, navigation cues 410 and 412 are displayed on opposite sides of the state element 414 and are opposite emotions, such as “rage” and “terror”. Emotions may be selected by the developer using any method desired, such as the Plutchik Wheel of Emotion. The current state identifier 416 displays in text form a description of the current state. In some embodiments, the current state identifier filed 416 may be selected to receive a custom text entry by entering a text label for a state identifier element, such that the user is automatically brought to the state element 414 that corresponds to the custom text entry. Text entries may be tracked such that a developer may be made aware of requested selections that may not currently exist. A button 418 may be used by a user to submit the user's final selection. As the user, for example, swipes the user's finger across the display area 402 to move toward a specific navigation cue, the state element 414, current state identifier 416, and navigation cues 410 change based on the direction of the swipe. For example, if the user swipes toward terror and away from rage, the state element 414 may be updated to display an emotion related to fear and less like rage. In addition, each step from cell to cell through the grid is stored in order to track the path and time a user took to arrive at their selection.

FIG. 4B displays the user device 106 after a selection has been made. In this example, the current state element 414′ is displayed with navigation cues 406′, 408′, 410′, and 412′ associated with the current state element 414′. The current state identifier 416′ displays the text of the description of the current state. In this embodiment, when the user is satisfied with the user selection, selecting the button 418 submits the user selection which is stored and/or transmitted to a server.

FIG. 5 depicts a user interface 500 for providing pain state information, according to one or more embodiments. The user interface 500 is displayed as a grid 502 for providing pain assessment. In the present embodiment, navigation cues 504, 506, 508, 510, 512, 514, 516, and 518 are displayed at opposite sides of the grid 502 as well as in the four corners of the grid 502 to provide a user assistance in selecting a current type of pain. In addition, the distance from the center of the grid 502 identifies a severity of the pain. As such a single selection of a cell provides multiple data points with great detail and accuracy.

FIGS. 6A-6B depicts a user interface 600 for providing emotional state information, according to one or more embodiments. FIG. 6A depicts a user device 106 when the state information grid is initiated. The display area is separated into two panes; a feedback area 602, and a gesture area 604. The state information grid contains elements similar to those in FIG. 2. A text identifier 610 is displayed to identify the current state element. The element representation 606 is displayed, however, additional representations, such as a color or sound associated with the current state element may also be provided. Navigation cues 608 are displayed around the element representation 606. In the present example, the navigation cues 406 and 408 are displayed on opposite sides of the element representation 606 and are opposite emotions, such as “serious” and “playful”, “happy” and “sad”. This permits the user to quickly narrow the state selection options to the most relevant options while eliminating or filtering out irrelevant state selection options. The gesture area 604 displays an instruction 611 and a starting gesture point 613.

FIG. 6B depicts a user device 106 user interface during navigation through the state information grid. The feedback area 602′ shows the current text identifier 612 for the current state element as well as the element representation 616 and navigation cues 614 for the current state element. The feedback area also includes a beacon 618. The beacon 618 moves around the perimeter of the element representation 616 and indicates where the user is currently located on the state information grid or the direction of their current input. In the present example, the beacon 618 shows that the user is in the bottom right quadrant of the state information grid or is progressing downward based on the direction of their input. The gesture area 604′ indicates a gesture point 620 in the gesture area 604′ where the user is currently located.

### Example Computer System

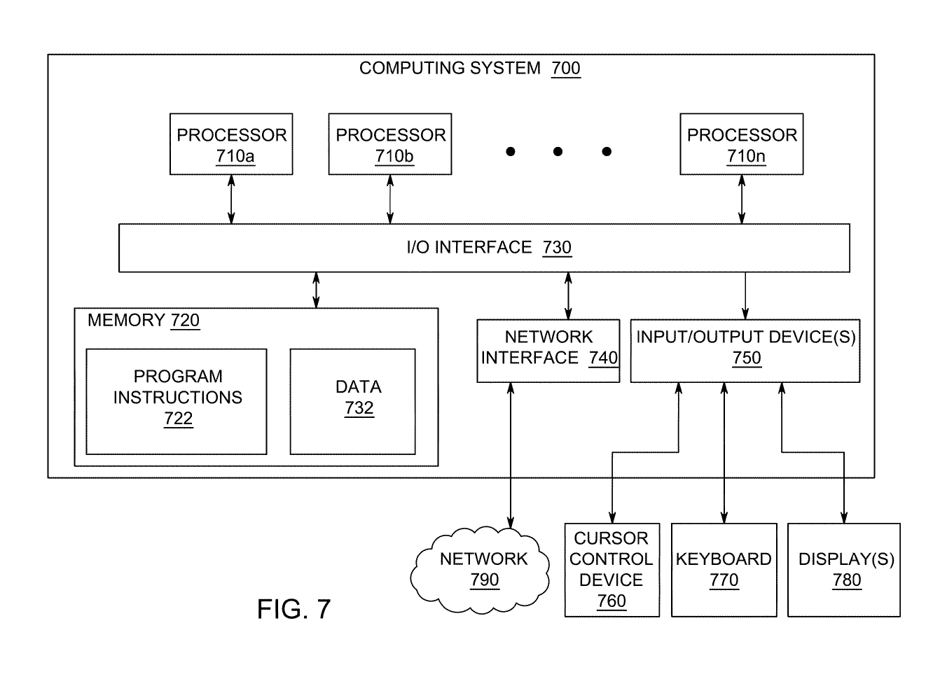

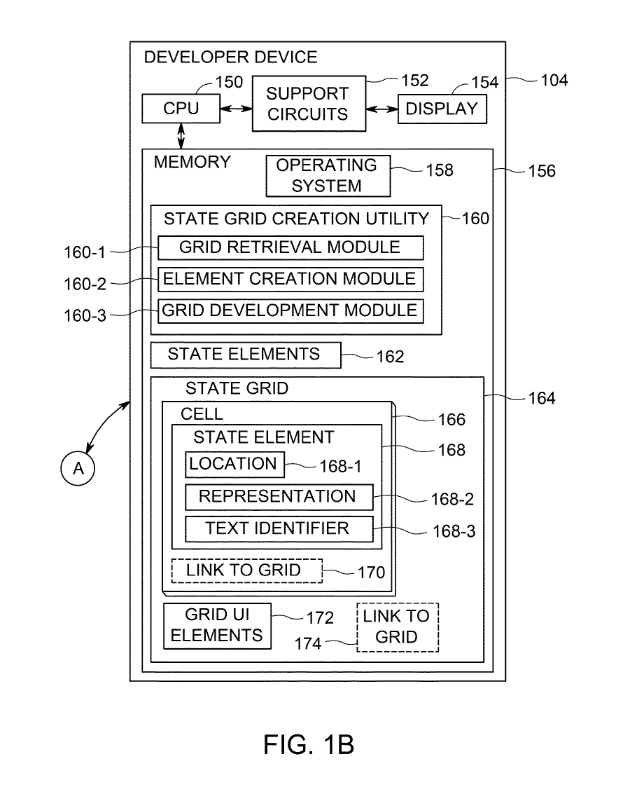

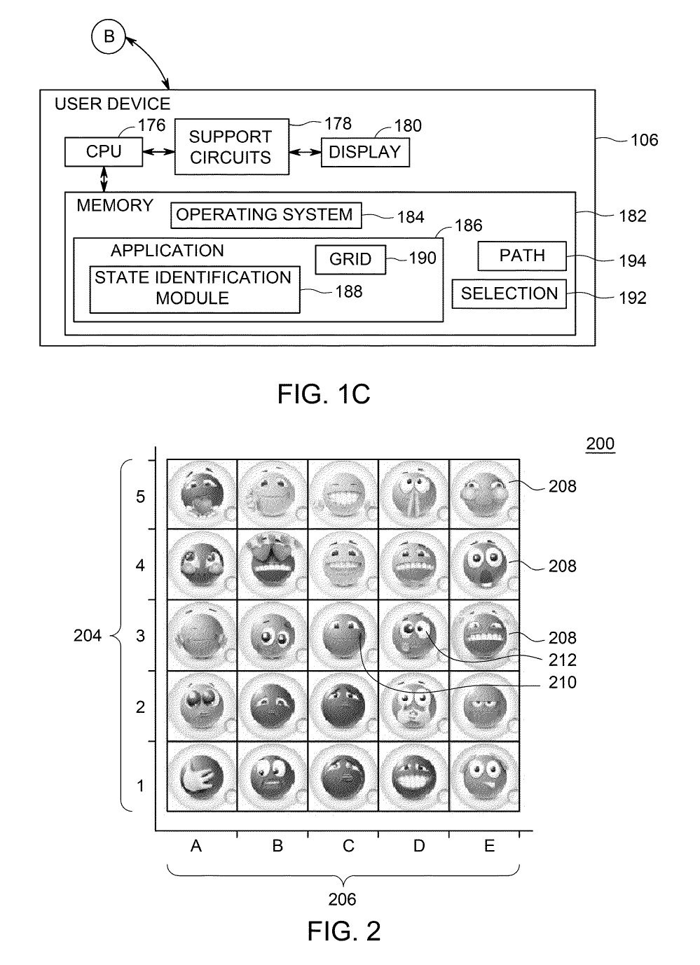

FIG. 7 depicts a computer system that can be utilized in various embodiments of the present invention, according to one or more embodiments.

Various embodiments of an apparatus and method for providing state identification, as described herein, may reside on or be executed on one or more computer systems, which may interact with various other devices. One such computer system is computer system 700 illustrated by FIG. 7, which may in various embodiments implement any of the elements or functionality illustrated in FIGS. 1-6. In various embodiments, computer system 700 may be configured to implement methods described above. The computer system 700 may be used to implement any other system, device, element, functionality or method of the above-described embodiments. In the illustrated embodiments, computer system 700 may be configured to implement method 300, as processor-executable executable program instructions 722 (e.g., program instructions executable by processor(s) 710a-n) in various embodiments.

In the illustrated embodiment, computer system 700 includes one or more processors 710a-n coupled to a system memory 720 via an input/output (I/O) interface 730. The computer system 700 further includes a network interface 740 coupled to I/O interface 730, and one or more input/output devices 750, such as cursor control device 760, keyboard 770, and display(s) 780. In various embodiments, any of components may be utilized by the system to receive user input described above. In various embodiments, a user interface (e.g., user interface) may be generated and displayed on a display 780. In some cases, it is contemplated that embodiments may be implemented using a single instance of computer system 700, while in other embodiments multiple such systems, or multiple nodes making up computer system 700, may be configured to host different portions or instances of various embodiments. For example, in one embodiment some elements may be implemented via one or more nodes of computer system 700 that are distinct from those nodes implementing other elements. In another example, multiple nodes may implement computer system 700 in a distributed manner.

In different embodiments, computer system 700 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 700 may be a uniprocessor system including one processor 710, or a multiprocessor system including several processors 710 (e.g., two, four, eight, or another suitable number). Processors 710a-n may be any suitable processor capable of executing instructions. For example, in various embodiments processors 710 may be general-purpose or embedded processors implementing any of a variety of instruction set architectures (ISAs), such as the x96, PowerPC, SPARC, or MIPS ISAs, or any other suitable ISA. In multiprocessor systems, each of processors 710a-n may commonly, but not necessarily, implement the same ISA.

System memory 720 may be configured to store program instructions 722 and/or data 732 accessible by processor 710. In various embodiments, system memory 720 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 720. In other embodiments, program instructions and/or data may be received, sent or stored upon different types of computer-accessible media or on similar media separate from system memory 720 or computer system 700.

In one embodiment, I/O interface 730 may be configured to coordinate I/O traffic between processor 710, system memory 720, and any peripheral devices in the device, including network interface 740 or other peripheral interfaces, such as input/output devices 750. In some embodiments, I/O interface 730 may perform any necessary protocol, timing or other data transformations to convert data signals from one components (e.g., system memory 720) into a format suitable for use by another component (e.g., processor 710). In some embodiments, I/O interface 730 may include support for devices attached through various types of peripheral buses, such as a variant of the Peripheral Component Interconnect (PCI) bus standard or the Universal Serial Bus (USB) standard, for example. In some embodiments, the function of I/O interface 730 may be split into two or more separate components, such as a north bridge and a south bridge, for example. Also, in some embodiments some or all of the functionality of I/O interface 730, such as an interface to system memory 720, may be incorporated directly into processor 710.

Network interface 740 may be configured to allow data to be exchanged between computer system 700 and other devices attached to a network (e.g., network 790), such as one or more external systems or between nodes of computer system 700. In various embodiments, network 790 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 740 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 750 may, in some embodiments, include one or more display terminals, keyboards, keypads, touchpads, scanning devices, sensors, voice, electrical pulses, or optical recognition devices, or any other devices suitable for entering or accessing data by one or more computer systems 700. Multiple input/output devices 750 may be present in computer system 700 or may be distributed on various nodes of computer system 700. In some embodiments, similar input/output devices may be separate from computer system 700 and may interact with one or more nodes of computer system 700 through a wired or wireless connection, such as over network interface 740.

In some embodiments, the illustrated computer system may implement any of the methods described above, such as the methods illustrated by the flowchart of FIG. 3. In other embodiments, different elements and data may be included.

Those skilled in the art will appreciate that computer system 700 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, etc. Computer system 700 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 700 may be transmitted to computer system 700 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof.

1. A computer implemented method for providing state identification comprising:
(a) displaying a first state identifier, wherein the state identifier comprises a first state element and a first plurality of navigation cues associated with the first state element;
(b) receiving an input to move toward one of the first plurality of navigation cues;
(c) storing the first state element in a navigation path in response to the received input to move;
(d) displaying a second state element and a second plurality of navigation cues associated with the second state element;
(e) optionally repeating steps (b)-(d) for additional state elements to arrive at a final state element, which may be the second state element;
(f) receiving a selection of the final state element; and
(g) storing the selected final state element and updating the navigation path based on the received selection.

2. The method of claim 1, further comprising storing a timestamp associated with a time the input to move is received; and storing the time in the navigation path with the stored state element.

3. The method of claim 1, further comprising:
displaying a second state identifier based on the selected second state element, wherein the second state identifier provides additional state elements available for selection, and wherein the additional state elements define additional state elements associated with or relevant to the second state element.

4. The method of claim 1, further comprising:
displaying a third state identifier, wherein the third state identifier provides additional state elements available for selection, and wherein the additional state elements are elements related to a subject first state identifier.

5. The method of claim 1, wherein the first state identifier comprises a grid of cells, wherein each cell comprises a unique state element, wherein the unique state element comprises a location in the grid, a representation, and text identification.

6. The method of claim 5, wherein the state element is one of a psychological state, a physiological state, an emotional state, or an environmental state.

7. The method of claim 5, wherein the navigation cues comprise a text identification of one or more state elements adjacent to a current state element in the state identification grid.

8. The method of claim 1, wherein the received input to move may be received from one of navigation buttons, a track ball, a computer mouse, an eye tracking camera, a touch screen, micro-electromagnetic systems sensor, or a brain computer interface (BCI).

9. The method of claim 1, further comprising displaying a text representation associated with the first state element, and updating the text representation to display a text representation associated with the second state element.

10. The method of claim 1, wherein the displaying is performed in a feedback area of a display screen and receiving an input is performed on a gesture area of the display screen.

11. The method of claim 1, wherein the first state element is one of a default state element or a state element based on previous user selections or data analytics.

12. An apparatus for providing state identification comprising:
a computer having one or more processors and further comprising:
a state identification module configured to:
(a) display a first state identifier, wherein the state identifier comprises a first state element and a first plurality of navigation cues associated with the first state element;
(b) receive an input to move toward one of the first plurality of navigation cues;
(c) store the first state element in a navigation path in response to the received input to move;
(d) display a second state element and a second plurality of navigation cues associated with the second state element;
(e) optionally repeat the process of (b)-(d) for additional state elements to arrive at a final state element, which may be the second state element;
(f) receive a selection of the final state element; and
(g) store the selected final state element and updating the navigation path based on the received selection.

13. The apparatus of claim 12, wherein the state identification module is further configured to store a timestamp associated with a time the input to move is received; and storing the time in the navigation path with the stored state element.

14. The apparatus of claim 12, wherein the state identification module is further configured to:
display a second state identifier based on the selected second state element, wherein the second state identifier provides additional state elements available for selection, and wherein the additional state elements define additional elements associated with or relevant to the second state element.

15. The apparatus of claim 12, wherein the state identification module is further configured to:
display a third state identifier, wherein the third state identifier provides additional state elements available for selection, and wherein the additional state elements are elements related to a subject first state identifier.

16. The apparatus of claim 12, wherein the first state identifier comprises a grid of cells, wherein each cell comprises a unique state element, wherein the unique state element comprises a location in the grid, a representation, and text identification, and wherein the state element is one of a psychological state, a physiological state, an emotional state, or an environmental state.

17. The apparatus of claim 16, wherein the navigation cues comprise a text identification of one or more state elements adjacent to a current state element in the state identification grid.

18. The apparatus of claim 12, wherein the received input to move may be received from one of a touch device, navigation buttons, a track ball, a computer mouse, an eye tracking camera, micro-electromagnetic systems sensor, or a brain computer interface (BCI).

19. A non-transitory computer readable medium for storing computer instructions that, when executed by at least one processor causes the at least one processor to perform a method for providing state identification comprising:
(a) displaying a first state identifier, wherein the state identifier comprises a first state element and a first plurality of navigation cues associated with the first state element;
(b) receiving an input to move toward one of the first plurality of navigation cues;
(c) storing the first state element in a navigation path in response to the received input to move;
(d) displaying a second state element and a second plurality of navigation cues associated with the second state element;
(e) optionally repeating the process of (b)-(d) for additional state elements to arrive at a final state element, which may be the second state element;
(f) receiving a selection of the final state element; and
(g) storing the selected final state element and updating the navigation path based on the received selection.

20. The computer readable medium of claim 19, further comprising storing a timestamp associated with a time the input to move is received; and storing the time in the navigation path with the stored state element.
